(19) United States
(12) Patent Application Publication
(10) Pub. No.: US 2018/0088452 A1
(43) Pub. Date: Mar. 29, 2018

(54) LIGHT SOURCE DEVICE, PROJECTION DISPLAY UNIT, AND DISPLAY SYSTEM

(71) Applicant: SONY CORPORATION, TOKYO (JP)

(72) Inventor: SHINICHIRO TAJIRI, KANAGAWA (JP)

(21) Appl. No.: 15/564,974

(22) PCT Filed: Apr. 5, 2016
(86) PCT No.: PCT/JP2016/061108

§ 371 Date: Oct. 6, 2017

(30) Foreign Application Priority Data
Apr. 20, 2015 (JP) 2015-085782

(51) Int. Cl. G03B 21/20; F21V 13/12; F21V 7/22; H04N 9/31; G03B 21/14

(52) U.S. Cl. CPC G03B 21/204; F21V 13/12; G03B 21/14; H04N 9/31; F21V 7/22

(57) ABSTRACT

A light source device (10) of the invention includes: a light source (11) that emits a light beam in a first wavelength region; an optical path splitting element (12) that splits an optical path of the light beam in the first wavelength region emitted from the light source into a first optical path and a second optical path; a first fluorescent body (131a) that is disposed on the first optical path, and emits a light beam in a second wavelength region by undergoing excitation by the light beam in the first wavelength region, the second wavelength region differing from the first wavelength region; a second fluorescent body (131b) that is disposed on the second optical path, and emits a light beam in a third wavelength region by undergoing excitation by the light beam in the first wavelength region, the third wavelength region differing from the first and second wavelength regions; and an optical path synthesizing element (12) that synthesizes the light beam in the second wavelength region emitted from the first fluorescent body and the light beam in the third wavelength region emitted from the second fluorescent body.

### TECHNICAL FIELD

The disclosure relates to: a light source device to be used as, for example an illumination in a projection display unit; a projection display unit; and a display system.

### BACKGROUND ART

In recent years, a projector (projection display unit) uses a light source device (illumination device) that irradiates a fluorescent body with light from an individual light source, such as a laser, to output fluorescence light as illumination light. Further, by adopting a so-called reflective configuration in which a fluorescent body is formed on a metal or other reflective material, it becomes possible to obtain a high output.

Meanwhile, in the field of user interfaces (UIs), invisible light such as infrared light in addition to visible light may be used, in some cases, in an electronic apparatus that includes a projection display unit as described above. For example, PTL 1 suggests a light source device using a fluorescent body, in which a near infrared light source (LED) is disposed, in addition to a light source (blue laser) for excitation of the fluorescent body.

### CITATION LIST

### Patent Literature

PTL 1: Japanese Unexamined Patent Application Publication No. 2014-21223

### SUMMARY OF INVENTION

However, the light source device disclosed in PTL 1 may involve an increased number (or types) of light sources. In addition, there has been a demand that a cooling mechanism should be provided for each light source. For this reason, it is difficult to allow the entire device to have a smaller size.

It is therefore desirable to provide: a light source device that makes it possible to achieve a simple and compact configuration in which a fluorescent body is used; and a projection display unit and a display system, each of which uses such a light source device.

A light source device according to an embodiment of the disclosure includes: a light source that emits a light beam in a first wavelength region; an optical path splitting element that splits an optical path of the light beam in the first wavelength region emitted from the light source into a first optical path and a second optical path; a first fluorescent body that is disposed on the first optical path, and emits a light beam in a second wavelength region by undergoing excitation by the light beam in the first wavelength region, the second wavelength region differing from the first wavelength region; a second fluorescent body that is disposed on the second optical path, and emits a light beam in a third wavelength region by undergoing excitation by the light beam in the first wavelength region, the third wavelength region differing from the first and second wavelength regions; and an optical path synthesizing element that synthesizes the light beam in the second wavelength region emitted from the first fluorescent body and the light beam in the third wavelength region emitted from the second fluorescent body.

A projection display unit according to an embodiment of the disclosure includes the above-described light source device according to the embodiment of the disclosure.

A display system according to an embodiment of the disclosure includes the above-described projection display unit according to the embodiment of the disclosure.

In the light source device, the projection display unit, and the display system according to the embodiments of the disclosure, the light source emits the light beam in the first wavelength region, and then the optical path splitting element splits the light beam into first and second optical paths. On the first optical path, the first fluorescent body generates fluorescence (emits fluorescence light) using the light beam in the first wavelength region as an excitation light beam, thereby emitting the light beam in the second wavelength region. On the second optical path, the second fluorescent body generates fluorescence using the light beam in the first wavelength region as an excitation light beam, thereby emitting the light beam in the third wavelength region. Then, the optical path synthesizing element synthesizes the light beams in the second and third wavelength regions that have been emitted to the respective optical paths, and outputs the synthesized light beam.

According to the light source device, the projection display unit, and the display system according to the embodiments of the disclosure, the light source emits the light beam in the first wavelength region, and then the optical path splitting element splits the light beam into first and second optical paths. On the first optical path, the first fluorescent body is used to emit the light beam in the second wavelength region. On the second optical path, the second fluorescent body is used to emit the light beam in the third wavelength region. Then, the optical path synthesizing element synthesizes the light beams in the second and third wavelength regions, and outputs the synthesized light beam. In this way, it is possible to output light beams in a plurality of wavelength regions by using a light source in a single wavelength region. It is possible to reduce the number (types) of light sources compared to a case where light sources for a plurality of different wavelength regions are arranged, thus allowing for reduction of cooling mechanisms. Consequently, it is possible to achieve a simple and compact device configuration in which a fluorescent body is used.

It is to noted that mere examples of the disclosure are described above. Effects of the disclosure are not limited to those described above, and may be other effects, or may further include other effects.

### BRIEF DESCRIPTION OF DRAWINGS

FIG. 1 is a schematic diagram illustrating a configuration example of a light source device according to a first embodiment of the disclosure.

FIG. 2 is a characteristic diagram of an example of wavelength regions (a blue light region, a green to red light region, and an infrared region) of the light source device illustrated in FIG. 1.

FIG. 3 is a characteristic diagram of optical characteristics of an optical path splitting/synthesizing element illustrated in FIG. 1.

FIG. 4 is a schematic diagram illustrating a configuration example of a light source device according to a first comparative example.

FIG. 5 is a schematic diagram illustrating a configuration example of a light source device according to a second comparative example.

FIG. 6 is a characteristic diagram of incident angle dependency of the transmittance of a dichroic mirror.

FIG. 7 is a schematic diagram illustrating a configuration example of a light source device according to a second embodiment of the disclosure.

FIG. 8 is a characteristic diagram of optical characteristics of an optical path splitting/synthesizing element illustrated in FIG. 8.

FIG. 9 is a schematic diagram illustrating a configuration example of a light source device according to a first modification example.

FIG. 10 is a schematic diagram illustrating a configuration example of a light source device according to a second modification example.

FIG. 11 is a schematic diagram illustrating a configuration example of a light source device according to a third modification example.

FIG. 12 is a functional block diagram of an overall configuration of a projection display unit according to a first application example.

FIG. 13 is a schematic view of a configuration of a display system according to a second application example.

FIG. 14 is a functional block diagram of the display system illustrated in FIG. 13.

FIG. 15 is a schematic view of a configuration of a display system according to a third application example.

### MODES FOR CARRYING OUT THE INVENTION

Some embodiments of the disclosure are described below in detail with reference to the accompanying drawings. It is to be noted that the description is given in the following order.

1. First embodiment (an example of a light source device in which an optical path of a light beam emitted from a light source unit is split into multiple optical paths, then the wavelengths of the light beams on the respective optical paths are converted, after which the light beams are synthesized and outputted)

2. Second embodiment (an example of a light source device in which an optical path of a light beam emitted from a light source unit is split into multiple optical paths with the use of polarization, then the wavelengths of the light beams on the respective optical paths are converted, after which the optical paths are synthesized and outputted)

3. Modification Example 1 (an example in which two types of fluorescent bodies are held by a single rotating body)

4. Modification Example 2 (an example of a case where transmission type wavelength converters are used)

5. Modification Example 3 (an example of a case where a transmission type wavelength converter is used)

6. Application Example 1 (an example of a projection display unit)

7. Application Examples 2 and 3 (an example of a display system)

### [Configuration]

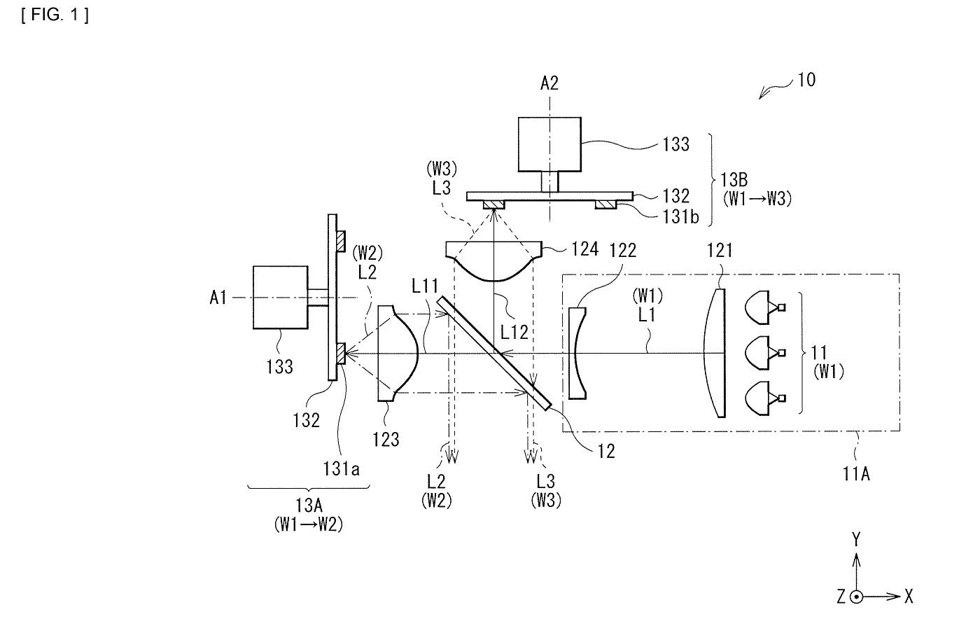

FIG. 1 illustrates a configuration example of a light source device (a light source device 10) according to a first embodiment of the disclosure. The light source device 10 is used as, for example, an illumination in a projection display unit (a projector) described later.

The light source device 10 includes: a light source unit 11A that includes a light source 11; an optical path splitting/synthesizing element 12; and wavelength converters 13A and 13B, for example. Lenses 121 and 122 are disposed in the light source unit 11A. A lens 123 is disposed between the optical path splitting/synthesizing element 12 and the wavelength converter 13A. A lens 124 is disposed between the optical path splitting/synthesizing element 12 and the wavelength converter 13B.

The light source 11 is a light source that emits a light beam in a wavelength region W1 (a first wavelength region). For example, the light source 11 may include a semiconductor laser (LD) or a light-emitting diode (LED). The light source 11 is an excitation light source for respective fluorescent bodies (fluorescent bodies 131a and 131b described later) in the wavelength converters 13A and 13B. The light source 11 emits a light beam in the wavelength region W1, such as a light beam in a blue light region, namely, a blue light beam. It is to be noted that the light beam in the wavelength region W1 as used herein refers to a light beam having an emission intensity peak in the wavelength region W1.

The optical path splitting/synthesizing element 12 is an element that splits an optical path of a light beam (L1) in the wavelength region W1 emitted from the light source unit 11A by transmitting a portion of the light beam L1 and reflecting the remaining portion, and synthesizes light beams with converted wavelengths (a light beam L2 in a wavelength region W2 and a light beam L3 in a wavelength region W3). The optical path splitting/synthesizing element 12 is configured by a dichroic mirror, for example, and is positioned with its plane of incidence or reflection forming an angle of 45 degrees with its incident optical path, for example. It is to be noted that the optical path splitting/synthesizing element 12 may be an element that has the functions of both an “optical path splitting element” and an “optical path synthesizing element” of the disclosure. In other words, in this configuration example, the “optical path splitting element” also serves as the “optical path synthesizing element”. Further, the optical path splitting/synthesizing element 12 is not limited to the dichroic mirror. Alternatively, the optical path splitting/synthesizing element 12 may be configured by a dichroic prism.

In the present embodiment, for example, the optical path splitting/synthesizing element 12 is configured to split the optical path of the incoming light beam L1 into an optical path (first optical path) extending in a travel direction of the light beam L1 (negative direction of the X axis) and an optical path (second optical path) extending in a direction perpendicular to the travel direction of the light beam L1 (positive direction of the Y axis). In FIG. 1, a light beam of the light beam L1 which passes through the optical path splitting/synthesizing element 12 (light traveling in the negative direction of the X axis) is depicted as a light beam L11. A light beam of the light beam L1 which is reflected by the optical path splitting/synthesizing element 12 (light traveling in the positive direction of the Y axis) is depicted as a light beam L12. Furthermore, the optical path splitting/synthesizing element 12 is configured to synthesize the light beam L2 in the wavelength region W2 and the light beam L3 in the wavelength region W3 and to emit the synthesized light beam (in the same direction). The synthesized light beam of these light beams L2 and L3 constitutes an output of the light source device 10.

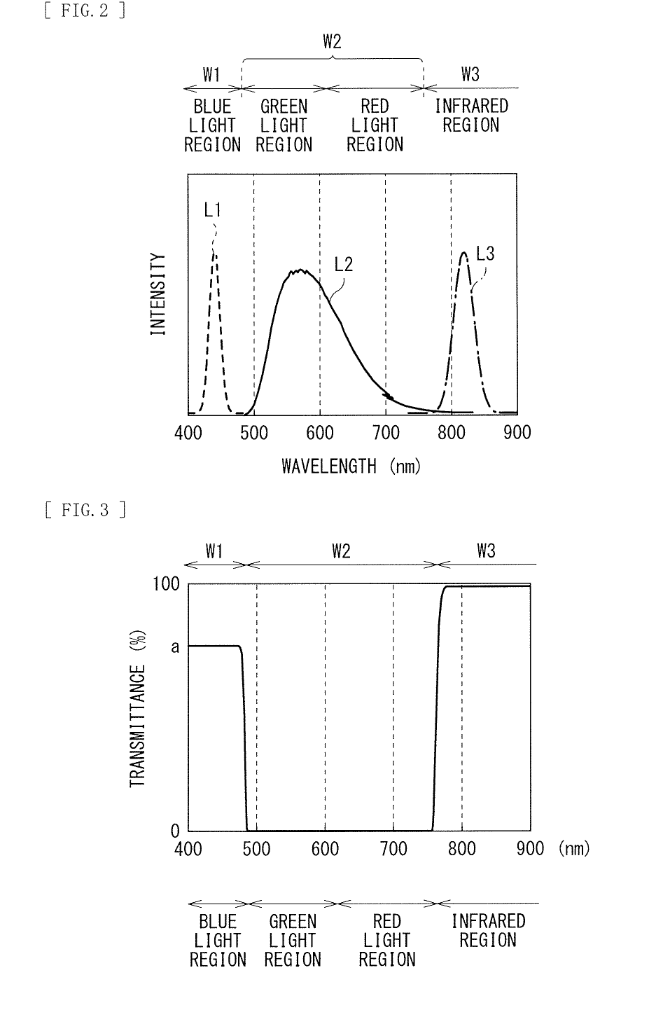

FIG. 2 illustrates examples of wavelength regions W1 to W3. As illustrated, for example, the wavelength region W1 is a blue light region; the wavelength region W2 is a wavelength region covering a green light region and a red light region, namely, a yellow wavelength region; and the wavelength region W3 is an infrared region or a near infrared region. In this case, a blue laser is used as the light source 11, and the emission intensity of the light beam L1 has a peak in the wavelength region W1. The wavelength region W1 ranges from 430 nm to 480 nm, for example. The wavelength region W2 ranges from 480 nm to 700 nm, for example. The wavelength region W3 ranges from 700 nm to 2000 nm, for example.

An example of a combination of the wavelength regions W1 to W3 is described below in Table 1. It is to be noted that Example 1 in Table 1 corresponds to the combination of the wavelength regions W1 to W3 in the present embodiment.

TABLE 1

| | Wavelength Region | | |
|---|---|---|---|
| | W1 | | |
| | (Excitation | Wavelength | Wavelength |
| | Wavelength) | Region W2 | Region W3 |
| Example 1 | Blue Light Region | Green to Red Light | Infrared Region |
| | | Region (Yellow) | |
| Example 2 | Ultraviolet Region | Green to Red Light | Infrared Region |
| | | Region (Yellow) | |
| Example 3 | Blue Light Region | Green Light Region | Red Light Region |
| Example 4 | Ultraviolet Region | Green Light Region | Red Light Region |
| Example 5 | Ultraviolet Region | Green to Red Light | Blue Light Region |
| | | Region (Yellow) | |
| Example 6 | Blue Light Region | Green to Red Light | Red Light Region |
| | | Region (Yellow) | |

As in Example 2 in Table 1, the wavelength region W1 of the light beam, i.e., the excitation light beam, emitted from the light source 11 is not limited to the blue light region, and may be an ultraviolet region, such as a wavelength region ranging from 300 nm to 430 nm. In this case, for example, an ultraviolet (UV) laser may be used as the light source 11. As in Examples 3 and 4, the wavelength region W2 may be a green light region, such as a wavelength region ranging from 480 nm to 590 nm, and the wavelength region W3 may be a red light region, such as a wavelength region ranging from 580 nm to 700 nm. Further, as in Example 5, the wavelength region W1 may be an ultraviolet region, the wavelength region W2 may be a wavelength region covering a green light region and a red light region, and the wavelength region W3 may be a blue light region. In addition, as in Example 6, the wavelength region W1 may be a blue light region, the wavelength region W2 may be a wavelength region covering a green light region and a red light region, and the wavelength region W3 may be a red light region.

As described above, the combination of the wavelength regions W1 to W3 is not especially limiting, and may take various forms of combination depending on applications. As in Examples 1 and 2, for example, the wavelength region W3 is set to be an infrared region for special displaying applications, such as a night vision device or applications other than displaying, such as sensing. As in Examples 3 to 6, alternatively, each of the wavelength regions W2 and W3 may be set to be a combination of wavelength regions within a visible region for applications in which a color purity of illumination light is enhanced or a shade is added to illumination light.

FIG. 3 illustrates an example of optical characteristics of the optical path splitting/synthesizing element 12, i.e., transmittances in the wavelength regions W1 to W3. The optical path splitting/synthesizing element 12 is designed such that its transmittances (reflectances) in wavelength regions W1 to W3, as described above, differ from one another. For example, the optical path splitting/synthesizing element 12 is designed such that: its transmittance (reflectance) in the wavelength region W1 becomes a % (100−a) %; its transmittance (reflectance) in the wavelength region W2 becomes substantially 0% (substantially 100%); and its transmittance (reflectance) in the wavelength region W3 becomes substantially 100% (substantially 0%). By adjusting transmittance “a” in the wavelength region W1, it is possible to: flexibly set a ratio of a transmission amount to a reflection amount of the optical path splitting/synthesizing element 12 (a split or distribution ratio of the light beam L11 to the light beam L12 of the light beam L1), i.e., an intensity ratio of light beam L2 in the wavelength region W2 to the light beam L3 in the wavelength region W3, depending on applications. In some layouts of the optical system, the transmittance in the wavelength region W2 is set to substantially 100%, and the transmittance in the wavelength region W3 is set to substantially 0%. In other words, the optical path splitting/synthesizing element 12 may transmit one of the light beams in the wavelength regions W2 and W3, and reflect the other.

Each of the wavelength converters 13A and 13B is an element that has a function of converting the wavelength region W1 of an incoming light beam into the wavelength region W2 or W3. In the present embodiment, both of the wavelength converters 13A and 13B employ a so-called reflective type which reflects fluorescent beams generated in response to entry of excitation light beams to output the reflected fluorescent beams.

The wavelength converter 13A is provided with the fluorescent body 131a that uses the light beam L11 in the wavelength region W1 as its excitation light and generates a fluorescent beam in the wavelength region W2. The fluorescent body 131a is held by a rotating body 132 (wheel) that has a disc shape, for example, and is disposed so as to at least partly face the optical path of the light beam L11, i.e., the first optical path. For example, the fluorescent body 131a in powder, glass, or crystalline form may be used. The rotating body 132 is coupled to a motor 133 (driver), and is rotatable around an axis A1 by means of driving power from the motor 133. In the rotating body 132, the fluorescent body 131a is held over a reflective member (plane of reflection). For example, the fluorescent body 131a is formed, on the rotating body 132, into a ring, arc, or disc shape, for example, with the axis A1 as the center. In this configuration, the motor 133 drives the rotating body 132 to rotate, thus causing the light beam L11 to be partly incident on the fluorescent body 131a in a circulating manner. It is to be noted that the wavelength converter 13A may be provided with an unillustrated cooling mechanism.

The wavelength converter 13B is provided with the fluorescent body 131b that uses the light beam L12 in the wavelength region W1 as its excitation light and generates a fluorescent beam in the wavelength region W3. The fluorescent body 131b is held by a rotating body 132 and disposed so as to at least partially face the optical path of the light beam L12, i.e., the second optical path. For example, the fluorescent body 131b in powder, glass, or crystalline form may be used. The rotating body 132 is rotatable around an axis A2 by means of driving power from a motor 133. In the rotating body 132, the fluorescent body 131b is held over a reflective member. The fluorescent body 131b is formed, on the rotating body 132, in a ring, arc, or disc shape, for example, with the axis A2 as the center. In this configuration, the motor 133 drives the rotating body 132 to rotate, thus causing the light beam L12 to be partly incident on the fluorescent body 131b in a circulating manner. It is to be noted that the wavelength converter 13B may be provided with an unillustrated cooling mechanism.

It is to be noted that, in this example, the fluorescent bodies 131a and 131b are held by the respective rotating bodies 132 in the wavelength converters 13A and 13B. However, depending on exciting energy for the fluorescent bodies 131a and 131b, the rotating body 132 does not necessarily have to be provided. In other words, the fluorescent bodies 131a and 131b does not necessarily have to be rotated. In this case, the fluorescent bodies 131a and 131b may be simply disposed on the optical paths of the light beams L11 and L12, respectively.

The lenses 121 and 122 constitute a lens group that focuses the light beam L1 emitted from the light source 11 and causes the light beam L1 to be incident on the optical path splitting/synthesizing element 12. In this case, the two lenses 121 and 122 in the light source unit 11A are depicted. However, alternatively, a single lens or three or more lenses may be used. These lenses 121 and 122 guide the light beams L2 and L3 emitted, respectively, from the fluorescent bodies 131a and 131b to the optical path splitting/synthesizing element 12.

The lens 123 focuses light, i.e., the light beam L11, emitted from the optical path splitting/synthesizing element 12 and causes the light beam L11 to be incident on the fluorescent body 131a. In addition, the lens 123 guides light, i.e., the light beam L2 with a converted wavelength emitted from the fluorescent body 131a to the optical path splitting/synthesizing element 12. The lens 124 focuses light, i.e., the light beam L12, emitted from the optical path splitting/synthesizing element 12 and causes the light beam L12 to be incident on the fluorescent body 131b. In addition, the lens 124 guides light, i.e., the light beam L3 with a converted wavelength, emitted from the fluorescent body 131b to the optical path splitting/synthesizing element 12.

### [Workings and Effects]

In the light source device 10 in the present embodiment, when the light source 11 is driven and the light source unit 11A emits the light beam L1 in the wavelength region W1, this light beam L1 is incident on the optical path splitting/synthesizing element 12. Due to the optical characteristics illustrated in FIG. 3, the optical path splitting/synthesizing element 12 transmits a portion (light beam L11) of the light beam L1 in the wavelength region W1, and reflects the remaining portion (light beam L12. In this way, the optical path of the light beam L1 in the wavelength region W1 is split into the optical paths of the light beams L11 and L12.

After having passed through the optical path splitting/synthesizing element 12, the light beam L11 is focused, by the lens 123, on the fluorescent body 131a in the wavelength converter 13A. As a result, the fluorescent body 131a is excited by the light beam L11 in the blue light region, for example, to generate fluorescence of the light beam L2 in the wavelength region W2 covering the green and red light regions, for example. This light beam L2 with a converted wavelength is reflected on the rotating body 132, and enters the lens 123 again. Then, the light beam L2 is converted by the lens 123 into a parallel light beam, and is incident on the optical path splitting/synthesizing element 12.

After having been reflected by the optical path splitting/synthesizing element 12, the light beam L12 is focused, by the lens 124, on the fluorescent body 131b in the wavelength converter 13B. As a result, the fluorescent body 131b is excited by the light beam L12 in the blue light region, for example, thus generating fluorescence of the light beam L3 in the wavelength region W3, such as the infrared region. This light beam L3 with a converted wavelength is reflected by the rotating body 132, and enters the lens 124 again. Then, the light beam L3 is converted by the lens 124 into a parallel light beam and is incident on the optical path splitting/synthesizing element 12.

Due to the optical characteristics as illustrated in FIG. 3, when both the light beam L2 in the wavelength region W2 and the light beam L3 in the wavelength region W3 are incident on the optical path splitting/synthesizing element 12, the optical path splitting/synthesizing element 12 reflects the light beam L2 and transmits the light beam L3. As a result, the optical paths of the light beams L2 and L3 are synthesized. In other words, the colors of the light beams L2 and L3 are synthesized. The synthesized light beam of the light beams L2 and L3 constitutes an output of the light source device 10.

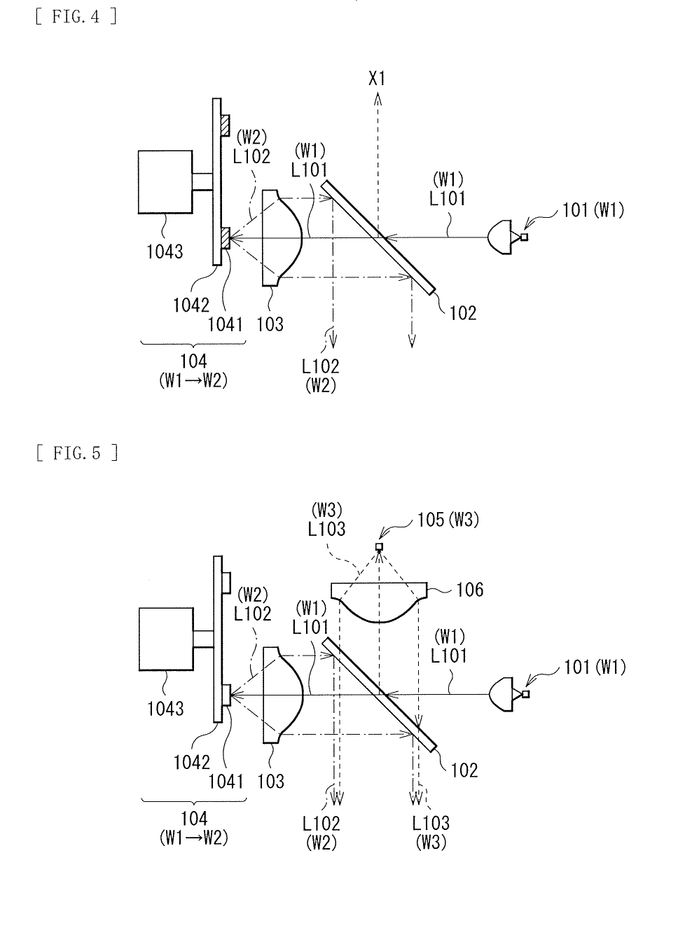

Here, FIG. 4 illustrates an example of a light source device that uses a fluorescent body, as a comparative example (Comparative Example 1) of the present embodiment. The light source device in Comparative Example 1 includes: a light source 101 that emits a light beam (a light beam L101) in the wavelength region W1; a dichroic mirror 102; a lens 103; and a wavelength converter 104. The dichroic mirror 102 is designed so as to, for example, reflect the wavelength region W2, while transmitting the wavelength region W1. The wavelength converter 104 includes a fluorescent body 1041, a rotating body 1042, and a motor 1043. In Comparative Example 1, the light beam L101 emitted from the light source 101 passes through the dichroic mirror 102, and then is focused on the fluorescent body 1041 by the lens 103. The fluorescent body 1041 is excited by the light beam L101, thus generating fluorescence of a light beam L102 in the wavelength region W2, which is reflected to the lens 103. The light beam L102 passes through the lens 103, and is incident on the dichroic mirror 102. The light beam L102 in the wavelength region W2 is reflected by the dichroic mirror 102.

Further, FIG. 5 illustrates another example of the light source device that uses the fluorescent body, as a comparative example (Comparative Example 2) of the present embodiment. As in Comparative Example 1 described above, the light source device in Comparative Example 2 includes the light source 101, the dichroic mirror 102, the lens 103, and the wavelength converter 104. In Comparative Example 2, however, the light source device further includes a light source 105 that emits a light beam in the wavelength region W3, such as infrared light. A lens 106 is disposed between the light source 105 and the dichroic mirror 102. Further, the dichroic mirror 102 is designed so as to, for example, reflect the wavelength region W2, while transmitting the wavelength regions W1 and W3. In this configuration, in Comparative Example 2, the light beam L101 emitted from the light source 101 passes through the dichroic mirror 102, and then is focused on the fluorescent body 1041, as in Comparative Example 1 described above. The fluorescent body 1041 is thereby excited by the light beam L101, thus generating fluorescence of the light beam L102 in the wavelength region W2. This light beam L102 is incident on the dichroic mirror 102 again through the lens 103, and is reflected by this dichroic mirror 102. A light beam L103 in the wavelength region W3 emitted from the light source 105 is incident on the dichroic mirror 102 through the lens 106, and passes through the dichroic mirror 102. In this way, the light beam L102 in the wavelength region W2 and the light beam L103 in the wavelength region W3 are synthesized and outputted from the light source device 10.

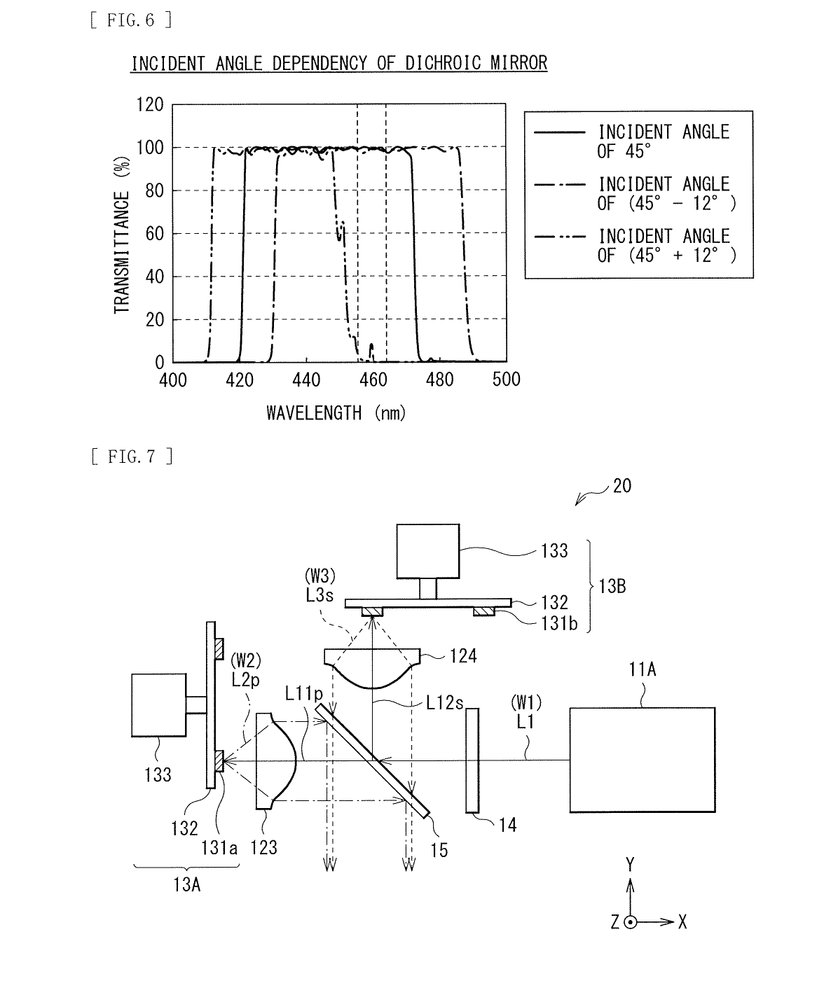

In each of Comparative Examples 1 and 2, the dichroic mirror 102 ideally transmits 100% of the light beam L101 in the wavelength region W1. In fact, however, it is difficult to maintain a characteristic of transmitting (or reflecting) 100% of light, because a transmission characteristic of the dichroic mirror 102 exhibits incident angle dependency and because a design is restricted by a manufacturing process. As illustrated in FIG. 6, for example, the transmittance of the dichroic mirror 102 at a wavelength varies depending on an incident angle. It is appreciated that the transmission characteristic acquired when light enters the plane of incidence or reflection of the dichroic mirror 102 at an angle of 45 degrees is different from that acquired when light enters the plane of incidence or reflection at an angle of (45+12) or (45−12) degrees. In this way, in fact, the light beam L101 in the wavelength region W1 that is to enter the dichroic mirror 102 includes light (leaked light X1) that does not pass through the dichroic mirror 102 but is reflected thereby. This results in lowered efficiency of light utilization.

In Comparative Example 2, this leaked light X1 enters the light source 105 such as an LED, thereby possibly damaging and degrading the light source 105. This may also cause an increase in temperature of the light source 105, thereby lowering its light emission efficiency. Furthermore, in a case of outputting light beams in a plurality of wavelength regions, including an infrared region, as in Comparative Example 2, when two or more types of light sources 101 and 105 are used, it is desirable that a cooling mechanism be provided for each light source due to increased number (or types) of light sources. Therefore, it is difficult to allow the entire device to have a smaller size.

In contrast, in the present embodiment, the optical path splitting/synthesizing element 12 splits the optical path of the light beam L1 in the wavelength region W1 emitted from the light source 11 (light source unit 11A). On the first optical path, which is one of the split optical paths, the fluorescent body 131a uses the light beam L1 in the wavelength region W1 as an excitation light beam to generate fluorescence (generate fluorescence emission), thus emitting the light beam L2 in the wavelength region W2. On the second optical path, which is the other of the split optical paths, the fluorescent body 131b uses the light beam L1 in the wavelength region W1 as an excitation light beam to generate fluorescence, thus emitting the light beam L3 in the wavelength region W3. The optical path splitting/synthesizing element 12 synthesizes the light beam L2 in the wavelength region W2 and the light beam L3 in the wavelength region W3 that have been emitted to the respective paths, and the light source device 10 outputs the synthesized light beam to its outside. In other words, it is possible to use the light source 11 that emits the light beam L1 in a single wavelength region (wavelength region W1) to synthesize light beams in a plurality of wavelength regions (wavelength regions W2 and W3) and output the synthesized light beam.

The foregoing embodiment makes it possible to use the light source 11 that emits the light beam L1 in the single wavelength region W1 to generate light beams in a plurality of wavelength regions (wavelength regions W2 and W3). It is possible to reduce the number of light sources compared to a case where (a plurality of types of) light sources for a plurality of different wavelength regions are arranged (as in Comparative Example 2), thus allowing for reduction of cooling mechanisms. Consequently, it is possible to achieve a simple and compact device configuration in which a fluorescent body is used.

Further, by adjusting a ratio of the transmittance (to the reflectance) of the optical path splitting/synthesizing element 12, it is possible to efficiently utilize not only transmitted light but also reflected light. This makes it possible to reduce an optical loss that is caused by the leaked light X1, unlike Comparative Examples 1 and 2, thereby controlling lowering of efficiency of light utilization. In addition, allowing for reduction of the number (or types) of light sources also leads to cost reduction.

Furthermore, by controlling the transmittance in the wavelength region W1 in the optical path splitting/synthesizing element 12, it is possible to adjust a distribution ratio between the wavelength regions W2 and W3. This enables various combinations of the wavelength regions W1 to W3 to be selected depending on applications. For example, it is possible to output rays having a color balance in accordance with a display image, as illumination light. In this case, by controlling the transmittance of the optical path splitting/synthesizing element 12, it is possible to set an appropriate color balance, thereby making it unnecessary to perform a gray-scale adjustment of an output of a display device. This makes unwanted rays less likely to enter the display device, thereby controlling a temperature rise of the display device (panel) and thus improving its reliability. The light source device 10 is also applicable to a night vision application in which the percentage of infrared light is larger than that of visible light.

Next, description is given of some embodiments and modification examples that are different from the foregoing first embodiment. In the following, same components as those of the foregoing first embodiment are provided with the same reference numerals as those of the foregoing first embodiment, and description thereof is omitted as appropriate.

### Second Embodiment

### [Configuration]

FIG. 7 illustrates a configuration example of a light source device (a light source device 20) according to a second embodiment of the disclosure. Similarly to the light source device 10 in the foregoing first embodiment, the light source device 20 is used as an illumination in a projection display unit described later. This light source device 20 includes: a light source unit 11A that includes a light source 11; a wave plate 14 (polarization rotating element); an optical path splitting/synthesizing element 15; wavelength converters 13A and 13B; and lenses 123 and 124, for example.

The light source unit 11A includes the light source 11 (which is not illustrated in FIG. 7) that emits a light beam in the wavelength region W1 (first wavelength region), and lenses 121 and 122, similarly to the foregoing first embodiment. In the present embodiment, however, as the light source 11, a light source is used that exhibits a linearly polarized light characteristic (emits a linearly polarized light beam), such as that of a semiconductor laser. It is to be noted that, in the light source unit 11A, the light source 11 may be disposed so as to be rotatable around its optical axis. In this case, it is possible to cause the light source 11 to emit a light beam with its polarization direction of the light beam L1 rotating without disposing the wave plate 14 described later.

The wave plate 14 alters or rotates a polarization direction of the light beam L1, which is a linearly polarized light beam, emitted from the light source unit 11A. The wave plate 14 includes a half-wave plate, for example. This wave plate 14 is disposed with its optical axis (slow axis or fast axis) inclined at a predetermined angle with respect to the polarization direction of the light beam L1 in a YZ plane. Specifically, the wave plate 14 is disposed such that the polarization direction of the light beam L1 to be incident on the optical path splitting/synthesizing element 15 is inclined at a predetermined angle, such as 45 degrees, with respect to a Z axis. Using the wave plate 14 makes it possible to adjust an inclination angle of the polarization direction of the light beam L1, thereby appropriately setting a ratio (splitting ratio) of the transmission amount of an s polarization component to the reflection amount of a p polarization component in the optical path splitting/synthesizing element 15. A drive mechanism that rotates the wave plate 14 around the optical axis may be provided. This drive mechanism may be used to automatically or manually control an orientation of the light beam L1 in the polarization direction. It is also possible to further provide a function of manually or automatically varying the splitting ratio of the p polarization component to the s polarization component in the optical path splitting/synthesizing element 15 (in accordance with an image to be displayed or projected, for example).

Similar to the optical path splitting/synthesizing element 12 in the foregoing first embodiment, the optical path splitting/synthesizing element 15 is an element that splits the optical path of the light beam L1 in the wavelength region W1 emitted from the light source unit 11A, and synthesizes light beams with converted wavelengths, i.e., the light beam L2 in the wavelength region W2 and the light beam L3 in the wavelength region W3. The optical path splitting/synthesizing element 15 is configured by a dichroic mirror, for example, and is disposed with its plane of incidence or reflection forming an angle of 45 degrees with respect to an X axis, for example. It is to be noted that the optical path splitting/synthesizing element 15 is not limited to a dichroic mirror. Alternatively, the optical path splitting/synthesizing element 15 may be configured by a dichroic prism or a polarization beam splitter (PBS).

In the present embodiment, however, the optical path splitting/synthesizing element 15 has a configuration in which a transmission characteristic (or reflection characteristic) varies in accordance with a polarization component. In FIG. 7, a first polarization component, such as a p polarization component, of the light beam L1 which passes through the optical path splitting/synthesizing element 15 is depicted as a light beam L11p, and a second polarization component, such as an s polarization component, of the light beam L1 which is reflected by the optical path splitting/synthesizing element 15 is depicted as a light beam L12s. In addition, the optical path splitting/synthesizing element 15 is configured to synthesize the light beam L2p in the wavelength region W2 and the light beam L3s in the wavelength region W3 and to emit the synthesized light beam (in the same direction). The synthesized light beam of the light beams L2p and L3s constitutes an output of the light source device 20.

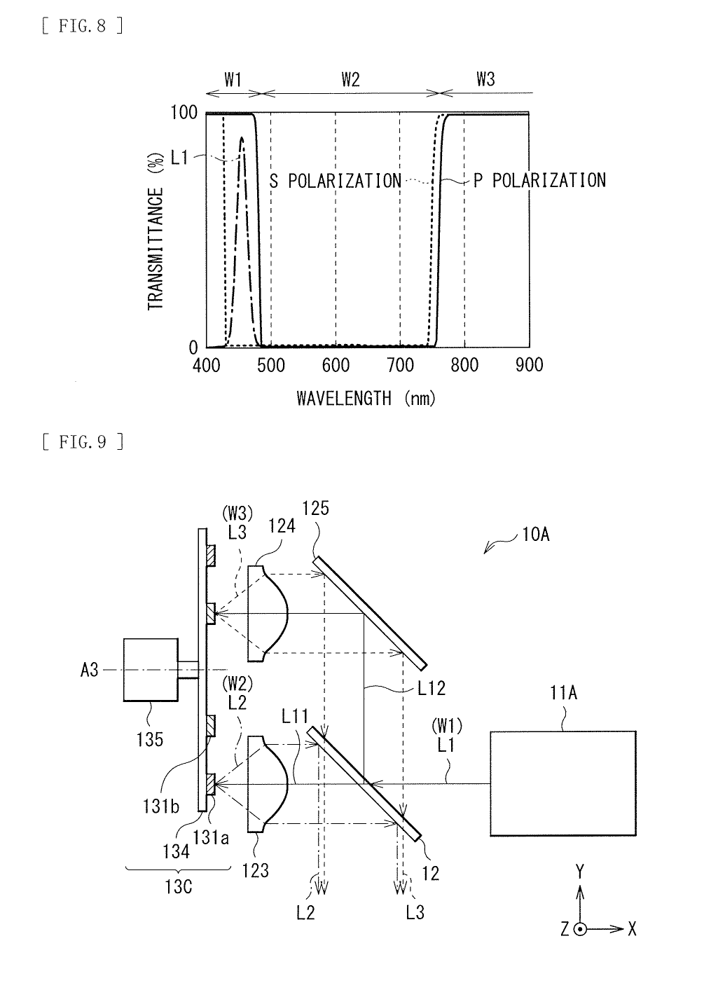

FIG. 8 illustrates an example of optical characteristics (transmittances for s and p polarization components in each of the wavelength regions W1 to W3) of the optical path splitting/synthesizing element 15. The optical path splitting/synthesizing element 15 is designed such that its transmittance (reflectance) for a p polarization component (solid line) and for an s polarization component (broken line) vary in the wavelength regions W1 to W3. For example, the transmittance for the p polarization component becomes substantially 100% (reflectance becomes substantially 0%) at least in a wavelength region corresponding to the light beam L1 of the wavelength region W1. In contrast, the transmittance for the s polarization component becomes substantially 0% (reflectance becomes substantially 100%). By adjusting an inclination angle of the polarization direction of the light beam L1 to be incident on the optical path splitting/synthesizing element 15 that exhibits the above characteristic, it is possible to appropriately set a ratio of a transmission amount for an s polarization component to a reflection amount for a p polarization component. For example, in a case where the polarization direction of the incident light beam L1 is inclined at an angle of 45 degrees with respect to the Z axis, the transmission amount for an s polarization component in the light beam L1 and the reflection amount for a p polarization component in the light beam L1 are both set to a half (substantially 50% each).

Meanwhile, the transmittances for the p and s polarization components each become substantially 0% (reflectances become substantially 100%) in the wavelength region W2. The transmittances for the p and s polarization components each become substantially 100% (reflectances become substantially 0%) in the wavelength region W3. In this way, by setting the optical path splitting/synthesizing element 15 such that its transmittance in the wavelength region W1 varies in accordance with a polarization component, it is possible to split the optical path of the light beam L1 in the wavelength region W1.

### [Workings and Effects]

In the light source device 20 in the present embodiment, the light source unit 11A emits the light beam L1 in the wavelength region W1, which is a linearly polarized light beam, and then the light beam L1 enters the wave plate 14. This wave plate 14 rotates the polarization direction of the light beam L1 so that the polarization direction is inclined at a predetermined angle, and then outputs the light beam L1. The light beam L1 having been emitted from the wave plate 14 is incident on the optical path splitting/synthesizing element 15, and the p polarization component, namely, the light beam L11p in the light beam L1 passes through the optical path splitting/synthesizing element 15, whereas the s polarization component, namely, the light beam L12s in the light beam L1 is reflected by the optical path splitting/synthesizing element 15. In this way, the optical path of the light beam L1 is split.

When the light beam L11p, i.e., a p polarization, having passed through the optical path splitting/synthesizing element 15 is focused, by the lens 123, on a fluorescent body 131a of a wavelength converter 13A, the light beam L2p, i.e., a p polarization, in the wavelength region W2 is generated due to fluorescent emission. This light beam L2p with a converted wavelength is reflected on a rotating body 132, and is incident on the optical path splitting/synthesizing element 15 through the lens 123.

Meanwhile, when the light beam L12s, i.e., an s polarization having been reflected by the optical path splitting/synthesizing element 15 is focused, by the lens 124, on a fluorescent body 131b of the wavelength converter 13B, the light beam L3s, i.e., an s polarization, in the wavelength region W3 is generated due to fluorescent emission. This light beam L3s with a converted wavelength is reflected on a rotating body 132, and is incident on the optical path splitting/synthesizing element 15 through the lens 124.

In this way, when the light beams L2p and L3s are incident on the optical path splitting/synthesizing element 15, the light beam L2p, i.e., the p polarization, in the wavelength region W2 is reflected by the optical path splitting/synthesizing element 15, whereas the light beam L3s, i.e., the s polarization, in the wavelength region W3 passes through the optical path splitting/synthesizing element 15, due to the optical characteristics illustrated in FIG. 8. As a result, the optical paths of the light beams L2p and L3s are synthesized. In other words, the colors of the light beams L2p and L3s are synthesized. The synthesized light beam of the light beams L2p and L3s constitutes an output of the light source device 20.

As described above, the light source device 20 in the present embodiment also makes it possible to use the light source 11 (light source unit 11A) which emits the light beam L1 in a single wavelength region, i.e., the wavelength region W1, to synthesize light beams in a plurality of wavelength regions (wavelength regions W2 and W3) and output the synthesized light beam. Consequently, it is possible to achieve effects similar to those of the foregoing first embodiment.

### Modification Example 1

FIG. 9 illustrates a configuration example of a light source device (a light source device 10A) according to Modification Example 1. The light source device 10A includes a light source unit 11A, an optical path splitting/synthesizing element 12, a wavelength converter 13C, lenses 123 and 124, and an optical path changing element 125, for example. In the wavelength converter 13C of the present modification example, a fluorescent body 131a that converts from the wavelength region W1 to the wavelength region W2 and a fluorescent body 131b that converts from the wavelength region W1 to the wavelength region W3 are held by the same rotating body (a rotating body 134).

The wavelength converter 13C is an element that has a function of converting the wavelength region W1 of an incident light beam into the wavelength regions W2 and W3, similarly to the wavelength converters 13A and 13B in the foregoing first embodiment. However, the wavelength converter 13C of the present modification example holds both the fluorescent bodies 131a and 131b on the rotating body 134 (wheel), with the plane of reflection therebetween.

The fluorescent bodies 131a and 131b are each formed, on the rotating body 134, into a ring shape, for example, with an axis A3 as each center, and are disposed concentrically. Each of the fluorescent bodies 131a and 131b are. The fluorescent body 131a is disposed so as to at least partly face an optical path (first optical path) of a light beam L11 while being held by the rotating body 134. The fluorescent body 131b is disposed so as to at least partly face an optical path (second optical path) of a light beam L12 while being held by the rotating body 134. The rotating body 134 is coupled to a motor 135 (driver), and thus is rotatable around the axis A3 by means of driving power from the motor 135. In this configuration, the motor 135 drives the rotating body 134 to rotate, thus causing the light beam L11 to be partly incident on the fluorescent body 131a in a circulating manner, whereas light beam L12 is partly incident on the fluorescent body 131b in a circulating manner. It is to be noted that an unillustrated cooling mechanism may be disposed on the wavelength converter 13C.

The optical path changing element 125 is configured by a mirror, for example, and converts an optical path of the split light beam L12 reflected (split) by the optical path splitting/synthesizing element 12 and causes the light beam L12 to be incident on the fluorescent body 131b of the wavelength converter 13C.

Also in the present modification example, similarly to the foregoing first embodiment, a portion (light beam L11) of the light beam L1 in the wavelength region W1 emitted from the light source unit 11A passes through the optical path splitting/synthesizing element 12, whereas the remaining portion (light beam L12) is reflected by the optical path splitting/synthesizing element 12, so that the optical path is split. When the light beam L11 having passed through the optical path splitting/synthesizing element 12 is focused, by the lens 123, on the fluorescent body 131a in the wavelength converter 13C, the light beam L2 in the wavelength region W2 is generated due to fluorescent emission. The light beam L2 with a converted wavelength is reflected on the rotating body 134, and is incident on the optical path splitting/synthesizing element 12 through the lens 123. In contrast, after the light beam L12 reflected by the optical path splitting/synthesizing element 12 undergoes an optical path change by the optical path changing element 125, the light beam L12 is focused, by the lens 124, on the fluorescent body 131b in the wavelength converter 13C, thus generating the light beam L3 in the wavelength region W3 due to fluorescent emission. This light beam L3 with a converted wavelength is reflected on the rotating body 134, and then is incident on the optical path splitting/synthesizing element 12 through the lens 124 and the optical path changing element 125. The light beam L2 in the wavelength region W2 is reflected by the optical path splitting/synthesizing element 12, whereas the light beam L3 in the wavelength region W3 passes through the optical path splitting/synthesizing element 12, similarly to in the foregoing first embodiment. As a result, the optical paths of the light beams L2 and L3 are synthesized. In other words, the colors of the light beams L2 and L3 are synthesized. The synthesized light beam of the light beams L2 and L3 constitutes an output of the light source device 10A.

In this way, also in the present modification example, it is possible to use the light source 11 (light source unit 11A) which emits the light beam L1 in a single wavelength region, i.e., in the wavelength region W1, to synthesize light beams in a plurality of wavelength regions, i.e., in the wavelength regions W2 and W3, and output the synthesized light beam. Consequently, it is possible to achieve effects similar to those of the foregoing first embodiment.

### Modification Example 2

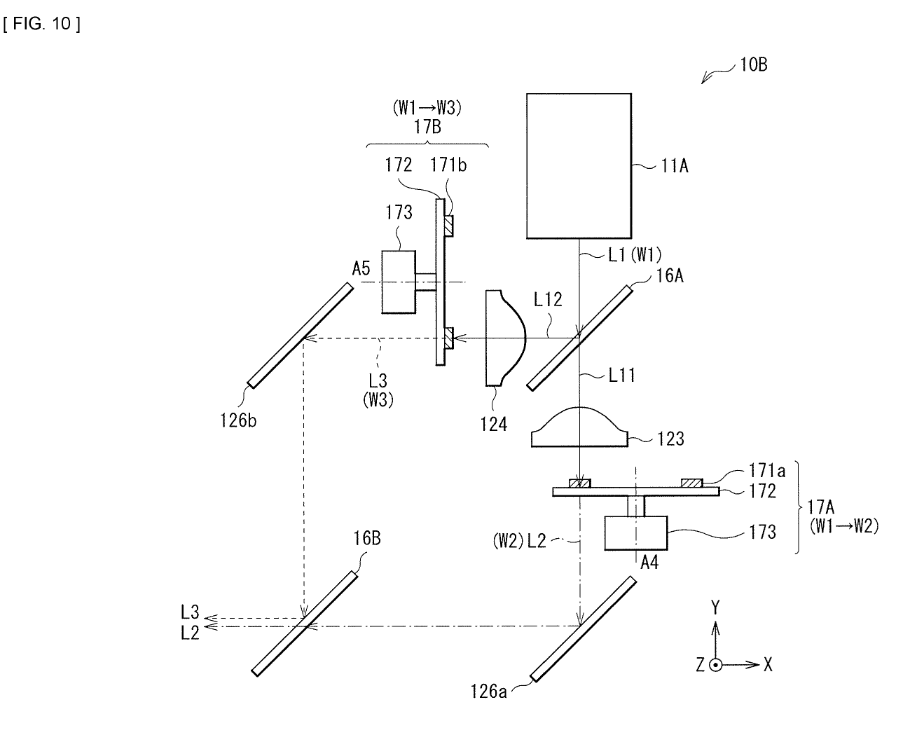

FIG. 10 illustrates a configuration example of a light source device (a light source device 10B) according to Modification Example 2. The light source device 10B includes a light source unit 11A, an optical path splitting element 16A, wavelength converters 17A and 17B, lenses 123 and 124, optical path changing elements 126a and 126b, and an optical path synthesizing element 16B, for example. In the present modification example, unlike the foregoing first embodiment, both of the wavelength converters 17A and 17B employ the so-called transmission type which transmits fluorescent beams generated in response to the entry of excitation light beams to output the transmitted fluorescent beams. In the foregoing first embodiment, the optical path splitting/synthesizing element 12 has both functions of splitting an optical path and synthesizing the optical paths. In the present modification example, however, the optical path splitting element 16A and the optical path synthesizing element 16B are disposed at different locations as separate members.

The optical path splitting element 16A is an element that splits an optical path of the light beam L1 in the wavelength region W1 emitted from the light source unit 11A. The optical path splitting element 16A transmits a portion of the light beam L1 in the wavelength region W1, and reflects the remaining portion, similarly to the optical path splitting/synthesizing element 12 in the foregoing first embodiment. The optical path splitting element 16A is configured by a dichroic mirror, for example, and is disposed with its plane of incidence or reflection forming an angle of 45 degrees with respect to an X axis, for example. It is to be noted that the optical path splitting/synthesizing element 15 is not limited to a dichroic mirror, and may be configured by a dichroic prism. In FIG. 10, a light beam of the light beam L1 which passes through the optical path splitting element 16A (light beam traveling in the negative direction of a Y axis) is depicted as a light beam L11. A light beam of the light beam L1 which is reflected by the optical path splitting element 16A (light beam traveling in the negative direction of the X axis) is depicted as a light beam L12.

The wavelength converter 17A is an element that has a function of converting the wavelength region W1 of the incident light beam into the wavelength region W2, similarly to the wavelength converter 13A in the foregoing first embodiment. In the wavelength converter 17A, a rotating body 172 holds a fluorescent body 171a thereon, and the fluorescent body 171a generates a fluorescent beam, which then passes through the rotating body 172. The fluorescent body 171a is formed into a ring, arc, or disc shape, for example, around an axis A4, similarly to the fluorescent body 131a in the foregoing first embodiment. Further, the fluorescent body 171a is disposed so as to at least partly face an optical path of the light beam L11 (first optical path) while being held by the rotating body 172. For example, a fluorescent body in powder, glass, or crystalline form may be used as the fluorescent body 171a. The rotating body 172 is coupled to a motor 173 (driver), and thus is rotatable around the axis A4 by means of driving power from the motor 173. In this configuration, the motor 173 drives the rotating body 172 to rotate, thus causing the light beam L11 to be partly incident on the fluorescent body 171a in a circulating manner. It is to be noted that an unillustrated cooling mechanism may be disposed on the wavelength converter 17A.

The wavelength converter 17B is an element that has a function of converting the wavelength region W1 of an incident light beam into the wavelength region W3, similarly to the wavelength converter 13B in the foregoing first embodiment. In the wavelength converter 17B, the rotating body 172 holds a fluorescent body 171b thereon, and the fluorescent body 171b generates a fluorescent beam, which then passes through the rotating body 172. The fluorescent body 171b is formed into a ring, arc, or disc shape around an axis A5, similarly to the fluorescent body 131b in the foregoing first embodiment. Further, the fluorescent body 171b is disposed so as to at least partly face an optical path (second optical path) of the light beam L12 while being held by the rotating body 172. For example, a fluorescent body in powder, glass, or crystalline form may be used as the fluorescent body 171b. The rotating body 172 is rotatable around the axis A5 by means of driving power from the motor 173. In this configuration, the motor 173 drives the rotating body 172 to rotate, thus causing the light beam L12 to be partly incident on the fluorescent body 171b in a circulating manner. It is to be noted that an unillustrated cooling mechanism may be disposed on the wavelength converter 17B.

Each of the optical path changing elements 126a and 126b is configured by a mirror, for example. The optical path changing element 126a changes an optical path of the light beam L2 (with a converted wavelength) which has passed through the wavelength converter 17A, and then causes the light beam L2 to be incident on the optical path synthesizing element 16B. The optical path changing element 126b converts an optical path of the light beam L3 (with a converted wavelength) which has passed through the wavelength converter 17B, and then causes the light beam L3 to be incident on the optical path synthesizing element 16B.

The optical path synthesizing element 16B synthesizes the optical paths of the light beams L2 and L3 in the respective wavelength regions W2 and W3 which have undergone an optical path change by the optical path changing elements 126a and 126b. In other words, the optical path synthesizing element 16B synthesizes the colors of the light beams L2 and L3. The optical path synthesizing element 16B is configured by a dichroic mirror, for example. It is to be noted that the optical path synthesizing element 16B may be configured by a dichroic prism.

Also in the present modification example, similarly to the foregoing first embodiment, a portion (light beam L11) of the light beam L1 in the wavelength region W1 emitted from the light source unit 11A passes through the optical path splitting element 16A, whereas the remaining portion (light beam L12) is reflected by the optical path splitting element 16A, so that the optical path is split. When the light beam L11 having passed through the optical path splitting element 16A is focused, by the lens 123, on the fluorescent body 171a in the wavelength converter 17A, the light beam L2 in the wavelength region W2 is generated due to fluorescent emission. The light beam L2 with a converted wavelength passes through the rotating body 172, undergoes an optical path change by the optical path changing elements 126a, and is then incident on the optical path synthesizing element 16B. In contrast, when the light beam L12 reflected by the optical path splitting element 16A is focused, by the lens 124, on the fluorescent body 171b of the wavelength converter 17B, the light beam L3 in the wavelength region W3 is generated due to fluorescent emission. This light beam L3 with a converted wavelength passes through the rotating body 172, undergoes an optical path change by the optical path changing elements 126b, and is then incident on the optical path synthesizing element 16B. The light beam L2 in the wavelength region W2 passes through the optical path synthesizing element 16B, whereas the light beam L3 in the wavelength region W3 is reflected by the optical path synthesizing element 16B. As a result, the optical paths of the light beams L2 and L3 are synthesized. In other words, the colors of the light beams L2 and L3 are synthesized. The synthesized light beam of the light beams L2 and L3 constitutes an output of the light source device 10B.

As in the present modification example, the optical path splitting element 16A and the optical path synthesizing element 16B may be separate members, and the wavelength converters 17A and 17B may each employ a transmission type. This configuration also makes it possible to use the light source 11 (light source unit 11A) which emits the light beam L1 in a single wavelength region, i.e., the wavelength region W1, to synthesize light beams in a plurality of wavelength regions, i.e., in the wavelength regions W2 and W3, and output the synthesized light beam. Consequently, it is possible to achieve effects similar to those of the foregoing first embodiment.

### Modification Example 3

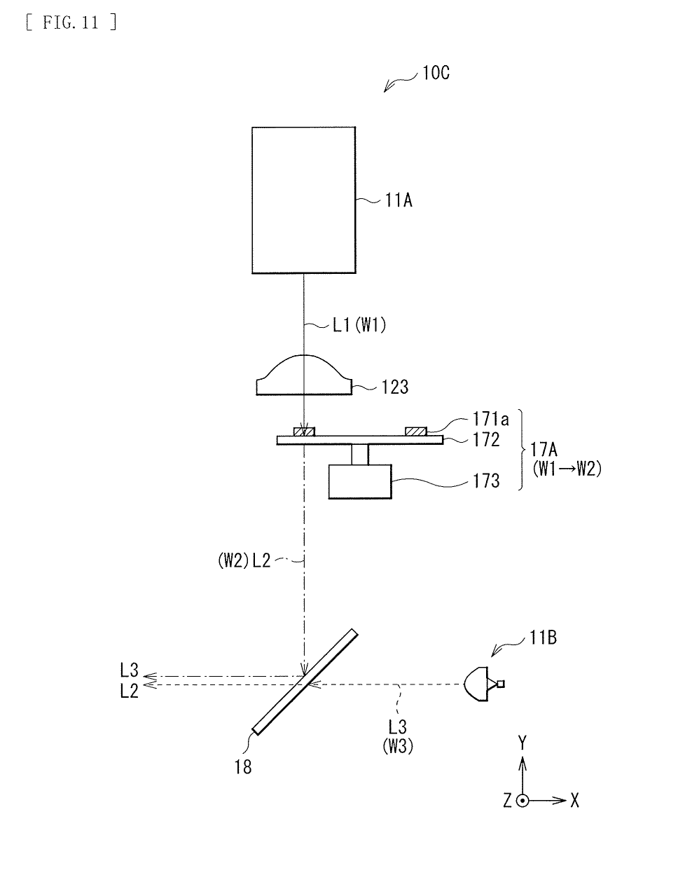

FIG. 11 illustrates a configuration example of a light source device (light source device 10C) according to Modification Example 3. The light source device 10C includes a light source unit 11A, a wavelength converter 17A, a lens 123, a light source 11B, and an optical path synthesizing element 18, for example. The light source 11B is a light source that emits the light beam L3 in a wavelength region W3, for example, and is configured by an LED or the semiconductor laser, for example. The optical path synthesizing element 18 synthesizes optical paths of the light beams L2 and L3 in the respective wavelength regions W2 and W3. In other words, the optical path synthesizing element 18 synthesizes the colors of the light beams L2 and L3. The optical path synthesizing element 18 is configured by a dichroic mirror, for example.

In the present modification example, the light beam L1 in the wavelength region W1 emitted by the light source unit 11A is focused, by the lens 123, on the fluorescent body 171a of the wavelength converter 17A, thus generating the light beam L2 in the wavelength region W2. This light beam L2 with a converted wavelength passes through the rotating body 172, and is incident on the optical path synthesizing element 18 along a Y axis of FIG. 11. In contrast, the light beam L3 in the wavelength region W3 emitted by the light source 11B is incident on the optical path synthesizing element 18 along an X axis of FIG. 11. The light beam L2 in the wavelength region W2 is reflected by the optical path synthesizing element 18, whereas the light beam L3 in the wavelength region W3 passes through the optical path synthesizing element 18. As a result, the optical paths of the light beams L2 and L3 are synthesized. In other words, the colors of the light beams L2 and L3 are synthesized. The synthesized color of the light beams L2 and L3 constitutes an output of the light source device 10C.

As in the present modification example, the configuration may be adopted in which the light-transmission type wavelength converter 17A and the light source 11B are used.

Next, description is given of some application examples of the light source device in the foregoing embodiments and modification examples. It is to be noted that the light source device 10 in the foregoing first embodiment is used for the following illustration and description. However, application examples are applicable to each of the light source devices in the foregoing second embodiment and Modification Examples 1 to 3.

### Application Example 1

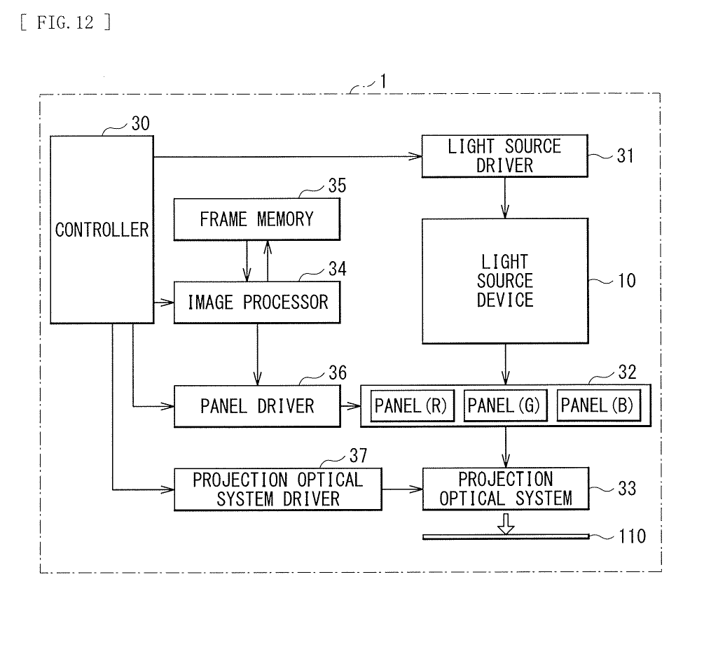

FIG. 12 is a functional block diagram illustrating an overall configuration of a projection display unit (projection display unit 1) according to Application Example 1. This projection display unit 1 is a display unit that projects an image onto a screen 110 (projection surface). The projection display unit 1 is coupled, via an interface (I/F), to an external image supply unit, such as a computer, e.g., a personal computer (PC), and various image players, all of which are not illustrated. In addition, the projection display unit 1 performs projection onto the screen 110 on the basis of an image signal inputted to the interface.

The projection display unit 1 includes a light source driver 31, the light source device 10, a light modulating device 32, a projection optical system 33, an image processor 34, a frame memory 35, a panel driver 36, a projection optical system driver 37, and a controller 30, for example.

The light source driver 31 outputs a pulse signal that controls a light emission timing of the light source 11 disposed in the light source device 10. For example, this light source driver 31 includes a PWM setting unit, a PWM signal generator, and a limiter, all of which are not illustrated. The light source driver 31 controls a light source driver in the light source device 10 and PWM-controls the light source 11 under control of the controller 30, thereby turning on and off the light source 11 or adjusting luminance of the light source 11.

In addition to the components described in the foregoing first embodiment, the light source device 10 includes the light source driver that drives the light source 11 and a current value setting section that sets a current value when the light source 11 is driven, for example, both of which are not illustrated. The light source driver may generate a pulse current having a current value set by the current value setting section, on the basis of a power source supplied from an unillustrated power supply circuit and in synchronization with a pulse signal inputted from the light source driver 31. The generated pulse current is supplied to the light source 11.

The light modulating device 32 modulates light, i.e., illumination light, outputted from the light source device 10 on the basis of the image signal, thereby generating image light beams. For example, the light modulating device 32 includes three transmission or reflective light valves corresponding to respective colors, such as R, G, and B. Examples of these light valves include a liquid crystal panel that modulates blue light (B), a liquid crystal panel that modulates red light (R), and a liquid crystal panel that modulates green light (G). For example, a liquid crystal element, such as liquid crystal on silicon (LCOS), may be used as a reflective liquid crystal panel. However, the light modulating device 32 is not limited to the liquid crystal element. Alternatively, other optical conversion elements, such as a digital micromirror device (DMD), may be used. The R, G, and B color light beams that have been modulated by the light modulating device 32 are synthesized by an unillustrated cross dichroic prism, for example, and then the synthesized color light beam is guided to the projection optical system 33.

The projection optical system 33 includes, for example, a lens group that projects the light beams modulated by the light modulating device 32 onto the screen 110, thereby forming an image thereon.

The image processor 34 acquires the image signal received from the outside to, for example, determine the size and resolution of an image and to identify whether the image is a still image or a moving image. In a case where the image is a moving image, the image processor 34 also determines attributes, such as a frame rate, of the image data, for example. Further, in a case where the resolution of the image signal acquired is different from the display resolution of each of the liquid crystal panels in the light modulating device 32, the image processor 34 performs a resolution conversion process. The image processor 34 expands the processed images for each frame in the frame memory 35, and outputs the images for each frame expanded in the frame memory 35 to the panel driver 36 as display signals.

The panel driver 36 drives the liquid crystal panels in the light modulating device 32. This driving operation of the panel driver 36 causes optical transmittances of the pixels arranged in each liquid crystal panel to be varied, thereby forming an image.

The projection optical system driver 37 includes a motor that drives lenses disposed in the projection optical system 33. This projection optical system driver 37 drives, for example, the projection optical system 33 under control of the controller 30, thereby adjusting zooming, focusing, and a diaphragm, for example.

The controller 30 controls the light source driver 31, the image processor 34, the panel driver 36, and the projection optical system driver 37.

By providing the projection display unit 1 with the above-described light source device 10, it is possible to achieve a simple and compact configuration of an entire device.

### Application Example 2

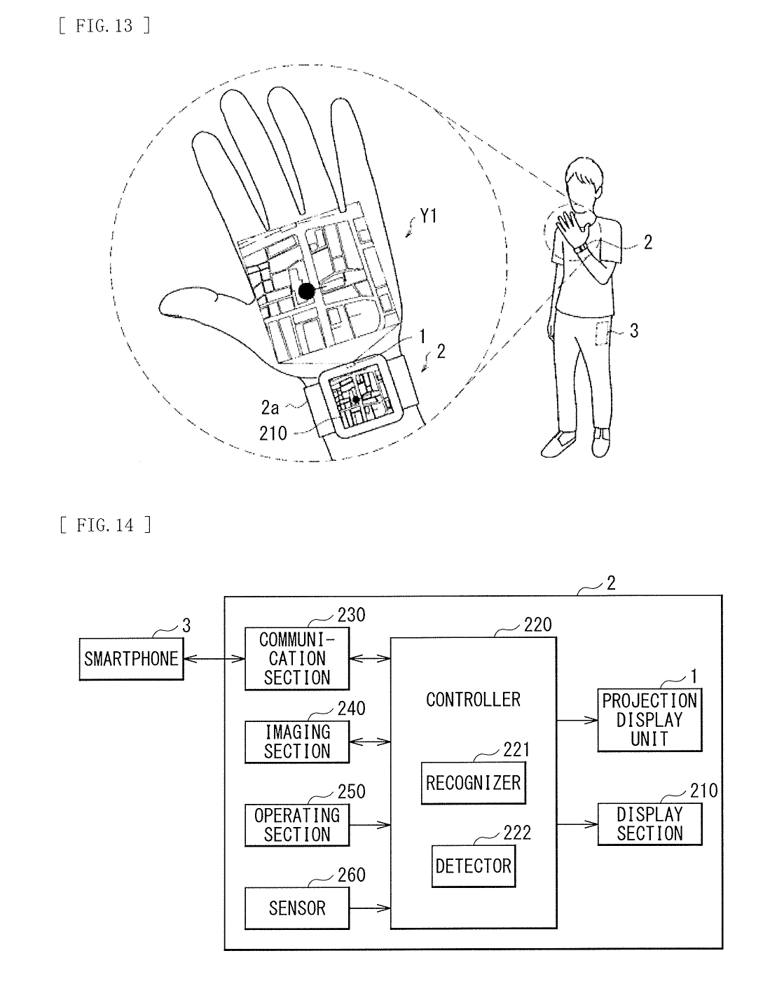

FIG. 13 schematically illustrates a configuration of a display system according to Application Example 2. FIG. 14 illustrates a functional configuration of the display system according to Application Example 2. This display system includes a wristband type terminal (wristband type information processor) 2 and a smartphone (external unit) 3.

For example, the smartphone 3 is an information processor that operates in cooperation with the wristband type terminal 2. The smartphone 3 has a function of transmitting an image to be projected or displayed to the wristband type terminal 2 and receiving information indicating a user's operation from the wristband type terminal 2. More specifically, the smartphone 3 transmits an image of a graphical user interface (GUI) to the wristband type terminal 2, and receives a signal indicating a user's operation of the GUI. Then, the smartphone 3 performs a process in accordance with the received user's operation, and transmits an image of the GUI updated with this process to the wristband type terminal 2.

It is to be noted that an external unit that operates in cooperation with the wristband type terminal 2 is not limited to a smartphone; the external unit may be another information processor, examples of which include a digital still camera, a digital video camera, a personal digital assistant (PDA), a personal computer (PC), a notebook personal computer (PC), a tablet terminal, a portable phone terminal, a portable music player, a portable image processor, and a portable gaming machine.

The wristband type terminal 2 includes, for example a display section 210 and the projection display unit 1 provided with a light source device, such as the light source device 10, in one of the foregoing embodiments and modification examples. The wristband type terminal 2 is used while being attached to a user's wrist, for example, by a band section 2a. The band section 2a is made of leather, metal, fabric, or rubber, for example, similarly to a watch band.

As illustrated in FIG. 14, for example, the wristband type terminal 2 further includes a controller 220, a communication section 230, an imaging section 240, an operating section 250, and a sensor 260. The wristband type terminal 2 is coupled to the smartphone 3 through wireless communication and operates in cooperation with the smartphone 3. For example, the wristband type terminal 2 may receive an image from the smartphone 3 placed in a pocket of user's clothes, and may display the image in the display section 210 or project the image onto a user's palm through the projection display unit 1.

The display section 210 displays an image, such as a still or moving image, under control of the controller 220. For example, the display section 210 includes a liquid crystal display (LCD) or an organic light-emitting diode (OLED). For example, the display section 210 is integrated with the operating section 250, and function as the so-called touch panel.

The communication section 230 transmits and receives a signal, such as an image signal or a user operation signal, to and from the smartphone 3. Examples of the communication scheme include wireless communication, Bluetooth (registered trademark), wireless high definition (WiHD), a wireless local area network (WLAN), wireless fidelity (Wi-Fi (registered trademark)), near field communication (NFC), and infrared communication. Furthermore, communication using 3G/LTE (long term evolution) or a radio wave in a millimeter band may be conducted.

For example, the imaging section 240 includes: a lens section that includes, for example, an imaging lens, a diaphragm, a zoom lens, and a focus lens; a driver that drives the lens section to perform a focusing or zooming operation; and a solid-state imaging device that generates an imaging signal on the basis of imaging light acquired through the lens section. For example, the solid-state imaging device is configured by a charge coupled device (CCD) or a complementary metal oxide semiconductor (CMOS) image sensor. The imaging section 240 outputs data on a captured image as a digital signal to the controller 220.

The operating section 250 has a function of receiving an input signal, i.e., the user operation signal, from the user. For example, the operating section 250 is configured by buttons, a touch sensor, or a trackball. In this case, the operating section 250 is integrated with the display section 210, thereby functioning as a touch panel. This operating section 250 outputs the inputted user control signal to the controller 220.

The sensor 260 has a function of acquiring information regarding a user's motion or state. For example, the sensor 260 is provided with a camera that is intended to capture an image of a user's face or eye, or the hand to which the wristband type terminal 2 is attached. In addition, for example, the sensor 260 may include a camera with a depth detecting function, a microphone, a GPS, an infrared sensor, a ray sensor, a myoelectric sensor, a nerve sensor, a sphygmus sensor, a body heat sensor, a gyroscope sensor, an acceleration sensor, and a touch sensor. Among these, the myoelectric sensor, the nerve sensor, the sphygmus sensor, and the body heat sensor may be provided in the band section 2a. This configuration enables the sensor 260 to perform a sensing operation near the user's hand, thereby allowing for accurate detection of the motion of the hand. The sensor 260 senses a user's motion or state and then outputs information indicating the sensing result to the controller 220.

The controller 220 functions as a processor and a controller, and controls an overall operation of the wristband type terminal 2 in accordance with various programs. The controller 220 is configured by a central processing unit (CPU) or a microphone processor, for example. This controller 220 may include a read only memory (ROM) that stores, for example, programs or arithmetic parameters to be used and a random access memory (RAM) that temporarily stores, for example, parameters varying as appropriate.

The controller 220 includes a recognizer 221 and a detector 222, for example, which allow for gesture input. The recognizer 221 has a function of recognizing the motion of the user's hand to which the band section 2a is attached. Specifically, the recognizer 221 recognizes the motion of the hand through, for example image and motion recognition using an image (e.g., image of captured user's hand) inputted from the sensor 260. The controller 220 performs various processes, such as a screen transition, on the basis of the recognition result from the recognizer 221. The detector 222 has a function of detecting a user's operation on an image Y1 projected by the projection display unit 1. For example, the detector 222 detect a user's operation on the projected image, such as a flick or a touch, of the projected image. The controller 220 transmits information indicating the user's operation detected by the detector 222 to the smartphone 3. Then, the smartphone 3 performs a process in accordance with the user's operation. This enables the wristband type terminal 2 to perform, in the display section 210 or on the user's hand, a function, such as the image transition, that is similar to a function to be performed in a case where the user performs an operation, such as a flick or a touch, of the touch panel of the smartphone 3. For example, when the user flicks the projected image Y1 vertically, the wristband type terminal 2 performs a function of scrolling the projected image Y1.

It is to be noted that, in the example of FIG. 13, a map image generated in the smartphone 3 using a global positioning system (GPS) function is displayed in the map image in the display section 210, and is projected as the projected image Y1 as well. The display section 210 has a limitation on its physical size, because the wristband type terminal 2 is intended to achieve portability. In some cases, it is difficult for the user to see an image displayed in the display section 210. In such cases, the projection display unit 1 is used to project the image onto the hand in an enlarged manner, for example, to an inch size similar to that of the smartphone 3, thus making it possible to enhances the visibility of the image. Furthermore, it is possible for the user to see an image, on his or her hand, which is received from the smartphone 3 being still placed in a pocket or a bag, thus leading to improvement of the usability.

In a display system as described above, in a case of adjusting the color balance of illumination light from the light source device 10, or in a case of utilizing infrared light in the sensor 260, for example, it is possible to suitably use the light source device, such as the light source device 10, in the foregoing embodiments and modification examples.

### Application Example 3

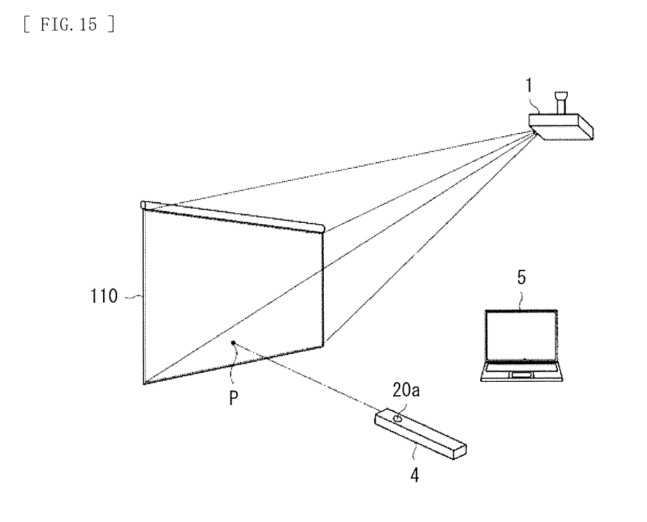

FIG. 15 schematically illustrates a configuration of a display system according to Application Example 3. This display system includes: the projection display unit 1 provided with the light source device, such as the light source device 10, in the foregoing embodiments and modification examples; a laser pointer 4; and a PC 5 that outputs a content to be projected to the projection display unit 1. Examples of the content to be projected includes a diagram, a text, any other various graphic image, a map, and a website.

The laser pointer 4 has a function of emitting an invisible or visible laser light beam in accordance with a user's pressing operation of an operation button 20a. The user may use the laser pointer 4 to irradiate an image projected onto a screen 110 with the laser light beam. This enables the user to, for example, make a presentation while pointing out a referenced area with an irradiated point P.

The PC 5 generates image data to be projected. Further, the PC 5 transmits this image data to the projection display unit 1 in a wired or wireless manner, and controls the projection. In FIG. 15, a notebook PC is depicted as an example of the PC 5; however, the PC 5 is not limited to the notebook PC. The PC 5 may be a desktop PC or a server on a network (cloud).

In this application example, the projection display unit 1 has an imaging section that projects an image received from the PC 5 onto the screen 110, and recognizes the irradiation of the projected image with the laser pointer 4. The imaging section enables detection using the invisible or visible laser light beam with which the screen 110 is irradiated. This imaging section may be mounted either inside or outside the projection display unit 1. By using the light source device, such as the light source device 10, in the foregoing embodiments and modification examples in the projection display unit 1, it is possible to output synthesized light beams in a plurality of wavelengths by using a single light source, as described above. This makes it possible to achieve a simple and compact configuration of an entire device without having to separately provide light sources used for projection and imaging.

Description has been given heretofore using some embodiments and modification examples. However, the disclosure is not limited to these embodiments and modification examples, and may be modified in a variety of ways. For example, the arrangement and the number of optical components (including one or more light source units, optical path splitting elements, lenses, optical path synthesizing elements, and optical path changing elements) exemplified in the embodiments and modification example are mere examples. Therefore, all of the components do not necessarily have to be provided, or another component may be further provided.

In the examples of the foregoing embodiments and modification examples, one or two types of fluorescent bodies convert a first wavelength region emitted from a light source (excitation light source). However, three or more types of the fluorescent bodies may also be used. Further, the number of light sources is not limited to one; two or more light sources may be disposed depending on applications, provided that it is possible to achieve a configuration in which the optical path of a light beam emitted from a single light source is split, then the light beams are guided to two or more types of fluorescent bodies, and the optical paths or colors of converted wavelengths are synthesized.

Furthermore, the projection display unit and the display system that have been described as application examples of the light source device in the foregoing embodiments and modification examples may be examples, and application examples are not limited to those described above. For example, the light source device of the disclosure is also applicable to a night vision device (night vision system) that use infrared light. It is to be noted that the effects described herein are mere examples and not limitative, and may further include other effects.

The disclosure may have the following configurations.

(1)

A light source device including:
a light source that emits a light beam in a first wavelength region;
an optical path splitting element that splits an optical path of the light beam in the first wavelength region emitted from the light source into a first optical path and a second optical path;
a first fluorescent body that is disposed on the first optical path, and emits a light beam in a second wavelength region by undergoing excitation by the light beam in the first wavelength region, the second wavelength region differing from the first wavelength region;
a second fluorescent body that is disposed on the second optical path, and emits a light beam in a third wavelength region by undergoing excitation by the light beam in the first wavelength region, the third wavelength region differing from the first and second wavelength regions; and
an optical path synthesizing element that synthesizes the light beam in the second wavelength region emitted from the first fluorescent body and the light beam in the third wavelength region emitted from the second fluorescent body.
   (2)

The light source device according to (1), in which the optical path splitting element serves also as the optical path synthesizing element.

(3)

The light source device according to (1) or (2), in which the optical path splitting element transmits, along the first optical path, a portion of the light beam in the first wavelength region emitted from the light source, and reflects, along the second optical path, another portion of the light beam in the first wavelength region emitted from the light source.

(4)

The light source device according to (2), in which the optical path splitting element transmits one of the light beam in the second wavelength region and the light beam in the third wavelength region, and reflects the other of the light beam in the second wavelength region and the light beam in the third wavelength region.

(5)

The light source device according to any one of (1) to (4), further including:
a first wavelength converter; and
a second wavelength converter,
the first wavelength converter including the first fluorescent body, a rotating body that holds the first fluorescent body, and a driver that drives the rotating body,
the second wavelength converter including the second fluorescent body, a rotating body that holds the second fluorescent body, and a driver that drives the rotating body.
   (6)

The light source device according to any one of (1) to (4), further including a third wavelength converter, the third wavelength converter including the first fluorescent body, the second fluorescent body, a rotating body that holds the first fluorescent body and the second fluorescent body, and a driver that drives the rotating body.

(7)

The light source device according to any one of (1) to (6), in which the optical path splitting element includes one of a dichroic mirror and a dichroic prism.

(8)

The light source device according to (5), in which each of the first wavelength converter and the second wavelength converter employs a reflective type.

(9)

The light source device according to (1) or (2), in which
the light source includes a light source that emits a linearly polarized light beam as the light beam in the first wavelength region, and
the optical path splitting element transmits a first polarization component of the light beam in the first wavelength region along the first optical path, and reflects a second polarization component of the light beam in the first wavelength region along the second optical path.
   (10)

The light source device according to (9), further including a polarization rotating element between the light source and the optical path splitting element.

(11)

The light source device according to (9) or (10), in which the optical path splitting element transmits one of the light beam in the second wavelength region and the light beam in the third wavelength region, and reflects the other of the light beam in the second wavelength region and the light beam in the third wavelength region.

(12)

The light source device according to any one of (9) to (11), in which the optical path splitting element includes a polarization beam splitter.

(13)

The light source device according to any one of (1) to (12), in which
the first wavelength region is a blue light region,
the second wavelength region covers a green light region and a red light region, and
the third wavelength region is an infrared region.
   (14)

The light source device according to any one of (1) to (12), in which
the first wavelength region is an ultraviolet region,
the second wavelength region covers a green light region and a red light region, and
the third wavelength region is an infrared region.
   (15)

The light source device according to any one of (1) to (12), in which
the first wavelength region is a blue light region,
the second wavelength region is a green light region, and
the third wavelength region is a red light region.
   (16)

The light source device according to any one of (1) to (12), in which
the first wavelength region is an ultraviolet region,
the second wavelength region covers a green light region, and
the third wavelength region is a red light region.
   (17)

The light source device according to any one of (1) to (12), in which
the first wavelength region is an ultraviolet region,
the second wavelength region covers a green light region and a red light region, and
the third wavelength region is a blue light region.
   (18)

The light source device according to any one of (1) to (12), in which
the first wavelength region is a blue light region,
the second wavelength region covers a green light region and a red light region, and
the third wavelength region is a red light region.
   (19)

A projection display unit provided with a light source device, the light source device including:
a light source that emits a light beam in a first wavelength region;
an optical path splitting element that splits an optical path of the light beam in the first wavelength region emitted from the light source into a first optical path and a second optical path;
a first fluorescent body that is disposed on the first optical path, and emits a light beam in a second wavelength region by undergoing excitation by the light beam in the first wavelength region, the second wavelength region differing from the first wavelength region;
a second fluorescent body that is disposed on the second optical path, and emits a light beam in a third wavelength region by undergoing excitation by the light beam in the first wavelength region, the third wavelength region differing from the first and second wavelength regions; and
an optical path synthesizing element that synthesizes the light beam in the second wavelength region emitted from the first fluorescent body and the light beam in the third wavelength region emitted from the second fluorescent body.
   (20)

A display system having a projection display unit, the projection display unit provided with a light source device, the light source device including:
a light source that emits a light beam in a first wavelength region;
an optical path splitting element that splits an optical path of the light beam in the first wavelength region emitted from the light source into a first optical path and a second optical path;
a first fluorescent body that is disposed on the first optical path, and emits a light beam in a second wavelength region by undergoing excitation by the light beam in the first wavelength region, the second wavelength region differing from the first wavelength region;
a second fluorescent body that is disposed on the second optical path, and emits a light beam in a third wavelength region by undergoing excitation by the light beam in the first wavelength region, the third wavelength region differing from the first and second wavelength regions; and
an optical path synthesizing element that synthesizes the light beam in the second wavelength region emitted from the first fluorescent body and the light beam in the third wavelength region emitted from the second fluorescent body.

This application is based upon and claims the benefit of priority of the Japanese Patent Application No. 2015-085782 filed with the Japan Patent Office on Apr. 20, 2015, the entire contents of which are incorporated herein by reference.

It should be understood that those skilled in the art can contemplate various modifications, combinations, sub-combinations, and variations on the basis of design requirements and other factors insofar as they are within the scope of the appended claims or the equivalents thereof.

1. A light source device comprising:
a light source that emits a light beam in a first wavelength region;
an optical path splitting element that splits an optical path of the light beam in the first wavelength region emitted from the light source into a first optical path and a second optical path;
a first fluorescent body that is disposed on the first optical path, and emits a light beam in a second wavelength region by undergoing excitation by the light beam in the first wavelength region, the second wavelength region differing from the first wavelength region;
a second fluorescent body that is disposed on the second optical path, and emits a light beam in a third wavelength region by undergoing excitation by the light beam in the first wavelength region, the third wavelength region differing from the first and second wavelength regions; and
an optical path synthesizing element that synthesizes the light beam in the second wavelength region emitted from the first fluorescent body and the light beam in the third wavelength region emitted from the second fluorescent body.

2. The light source device according to claim 1, wherein the optical path splitting element serves also as the optical path synthesizing element.

3. The light source device according to claim 2, wherein the optical path splitting element transmits, along the first optical path, a portion of the light beam in the first wavelength region emitted from the light source, and reflects, along the second optical path, another portion of the light beam in the first wavelength region emitted from the light source.

4. The light source device according to claim 2, wherein the optical path splitting element transmits one of the light beam in the second wavelength region and the light beam in the third wavelength region, and reflects the other of the light beam in the second wavelength region and the light beam in the third wavelength region.

5. The light source device according to claim 1, further comprising:
a first wavelength converter; and
a second wavelength converter,
the first wavelength converter including the first fluorescent body, a rotating body that holds the first fluorescent body, and a driver that drives the rotating body,
the second wavelength converter including the second fluorescent body, a rotating body that holds the second fluorescent body, and a driver that drives the rotating body.

6. The light source device according to claim 1, further comprising a third wavelength converter, the third wavelength converter including the first fluorescent body, the second fluorescent body, a rotating body that holds the first fluorescent body and the second fluorescent body, and a driver that drives the rotating body.

7. The light source device according to claim 1, wherein the optical path splitting element comprises one of a dichroic mirror and a dichroic prism.

8. The light source device according to claim 5, wherein each of the first wavelength converter and the second wavelength converter employs a reflective type.

9. The light source device according to claim 1, wherein
the light source comprises a light source that emits a linearly polarized light beam as the light beam in the first wavelength region, and
the optical path splitting element transmits a first polarization component of the light beam in the first wavelength region along the first optical path, and reflects a second polarization component of the light beam in the first wavelength region along the second optical path.

10. The light source device according to claim 9, further comprising a polarization rotating element between the light source and the optical path splitting element.

11. The light source device according to claim 9, wherein the optical path splitting element transmits one of the light beam in the second wavelength region and the light beam in the third wavelength region, and reflects the other of the light beam in the second wavelength region and the light beam in the third wavelength region.

12. The light source device according to claim 9, wherein the optical path splitting element comprises a polarization beam splitter.

13. The light source device according to claim 1, wherein
the first wavelength region is a blue light region,
the second wavelength region covers a green light region and a red light region, and
the third wavelength region is an infrared region.

14. The light source device according to claim 1, wherein
the first wavelength region is an ultraviolet region,
the second wavelength region covers a green light region and a red light region, and
the third wavelength region is an infrared region.

15. The light source device according to claim 1, wherein
the first wavelength region is a blue light region,
the second wavelength region is a green light region, and
the third wavelength region is a red light region.

16. The light source device according to claim 1, wherein
the first wavelength region is an ultraviolet region,
the second wavelength region covers a green light region, and
the third wavelength region is a red light region.

17. The light source device according to claim 1, wherein
the first wavelength region is an ultraviolet region,
the second wavelength region covers a green light region and a red light region, and
the third wavelength region is a blue light region.

18. The light source device according to claim 1, wherein
the first wavelength region is a blue light region,
the second wavelength region covers a green light region and a red light region, and
the third wavelength region is a red light region.

19. A projection display unit provided with a light source device, the light source device comprising:
a light source that emits a light beam in a first wavelength region;
an optical path splitting element that splits an optical path of the light beam in the first wavelength region emitted from the light source into a first optical path and a second optical path;
a first fluorescent body that is disposed on the first optical path, and emits a light beam in a second wavelength region by undergoing excitation by the light beam in the first wavelength region, the second wavelength region differing from the first wavelength region;
a second fluorescent body that is disposed on the second optical path, and emits a light beam in a third wavelength region by undergoing excitation by the light beam in the first wavelength region, the third wavelength region differing from the first and second wavelength regions; and
an optical path synthesizing element that synthesizes the light beam in the second wavelength region emitted from the first fluorescent body and the light beam in the third wavelength region emitted from the second fluorescent body.

20. A display system having a projection display unit, the projection display unit provided with a light source device, the light source device comprising:
a light source that emits a light beam in a first wavelength region;
an optical path splitting element that splits an optical path of the light beam in the first wavelength region emitted from the light source into a first optical path and a second optical path;
a first fluorescent body that is disposed on the first optical path, and emits a light beam in a second wavelength region by undergoing excitation by the light beam in the first wavelength region, the second wavelength region differing from the first wavelength region;
a second fluorescent body that is disposed on the second optical path, and emits a light beam in a third wavelength region by undergoing excitation by the light beam in the first wavelength region, the third wavelength region differing from the first and second wavelength regions; and
an optical path synthesizing element that synthesizes the light beam in the second wavelength region emitted from the first fluorescent body and the light beam in the third wavelength region emitted from the second fluorescent body.
